(19) United States
(12) Patent Application Publication
(10) Pub. No.: US 2007/0159463 A1
(43) Pub. Date: Jul. 12, 2007

(54) Wireless input apparatus capable of storing a receiver

(75) Inventor: Chun-Chung Huang, Taipei City (TW)

Correspondence Address: BIRCH STEWART KOLASCH & BIRCH, PO BOX 747, FALLS CHURCH, VA, 22040-0747, US

(73) Assignee: Darfon Electronics Corp.

(21) Appl. No.: 11/651,468

(22) Filed: Jan. 10, 2007

(30) Foreign Application Priority Data
Jan. 12, 2006 (TW) 095200704

(51) Int. Cl. G09G 5/08

(52) U.S. Cl. 345/163

(57) ABSTRACT

The present invention discloses a wireless input apparatus capable of storing a receiver that includes a main body and a receiver, and the main body has a detachable upper cap and a accommodating space disposed at the bottom of the upper cap and interconnected to the outside, and the receiver can be inserted from a rear end of the upper cap into the accommodating space, and a latch structure is disposed between the receiver and the accommodating space for connecting the receiver and the accommodating space, so as to store the receiver into the main body and achieve the effects of storing and carrying the wireless input apparatus easily.

### FIELD OF THE INVENTION

The present invention relates to a wireless input apparatus capable of storing a receiver, and more particularly, to a wireless mouse having a accommodating space disposed at the bottom of an upper cap of the wireless mouse for enabling a receiver of the wireless mouse to be received in the accommodating space.

### BACKGROUND OF THE INVENTION

Currently, there are many kinds of computer mouse available on the market, which are the most popular human-machine interface used by computers as cursor-control device. In addition to the classification by their functions, there are two basic types of mice, which are cable mice and wireless mice. Since wireless mice feature a cable-free advantage, therefore the wireless mice are becoming more and more popular. Generally, a wireless mouse requires a receiver connected to a computer system to transmit signals so as to enable the wireless mouse to communicate with the computer system. As the advance of technology, the receiver has evolved from a bulky device into a device no larger than a flash disk. Nevertheless, although the current receiver is a small device, it is still a device independent to and separate from the wireless mouse corresponding thereto, such that the whole package of a wireless mouse including a receiver is not easy to carry around since an additional bag is required for their storage, moreover, such package will occupy a certain space.

### SUMMARY OF THE INVENTION

In view of the disadvantages of prior art, the primary object of the present invention is to a wireless input apparatus capable of storing a receiver, which has a accommodating space disposed at the upper cap of the wireless input apparatus for storing the receiver and thus facilitating the storage and portability of the wireless input apparatus while reducing the volume of the same.

To achieve the above objective, the present invention provides a wireless input apparatus capable of storing a receiver, which comprise: a main body, having a detachable upper cap; and a receiver; wherein, an unsealed accommodating space is disposed at the bottom of the upper cap for enabling the receiver to be inserted from the rear end of the upper cap into the accommodating space; and a latch mechanism having matching clasp parts is disposed on the receiver and inside the accommodating space in respective for interlocking the receiver and the accommodating space and thus receiving the receiver inside the main body.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a schematic view of a wireless mouse according to a preferred embodiment of the present invention, whereas the upper cap is detached from the main body while the receiver is not received in the upper lid.

FIG. 2 is a schematic view of the wireless mouse of FIG. 1, whereas the upper cap is detached from the main body while the receiver is received inside the upper lid.

FIG. 3 is a schematic view of the wireless mouse of FIG. 1, whereas the upper cap is assembled to the main body while the receiver is received inside the upper lid.

FIG. 4 is a schematic view of a wireless mouse according to another preferred embodiment of the present invention.

FIG. 5 is a schematic diagram showing the inserting of a receiver into the wireless mouse of FIG. 4.

FIG. 6 is a schematic view of the wireless mouse of FIG. 4, whereas the receiver is received therein.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

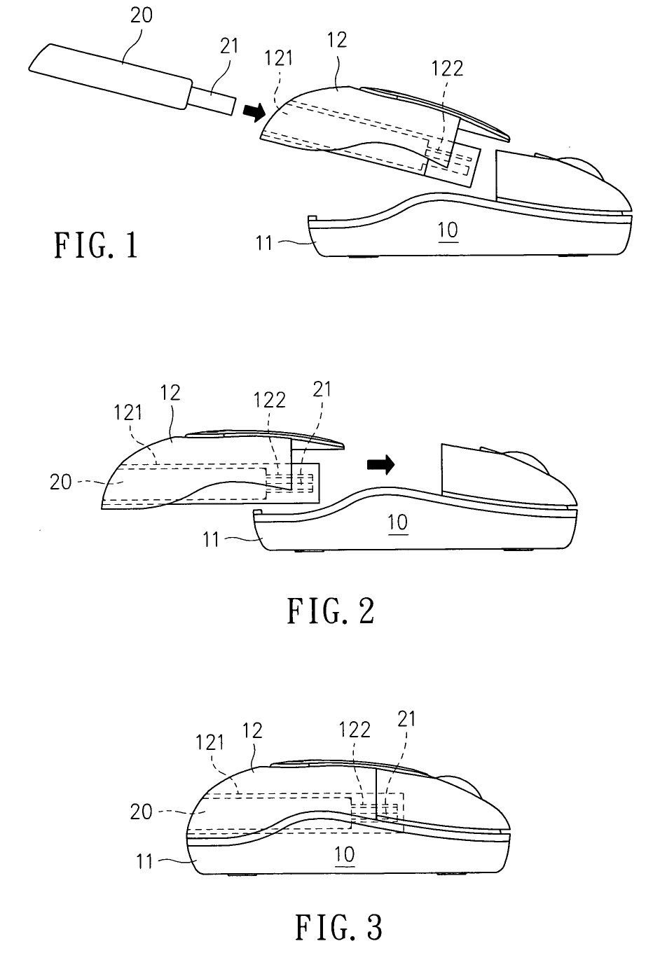

Please refer to FIGS. 1 to 3, which show a wireless input apparatus capable of storing a receiver according to a preferred embodiment of the present invention. As seen in FIG. 1, the wireless input apparatus 10 is a wireless mouse having a main body 11, and a detachable upper cap 12, whereas an accommodating space 121 is disposed at the bottom of the upper cap 12 that is unsealed at a rear end of the upper cap 12 and is in communication with outside world. As shown in FIG. 2, the receiver 20 can be inserted into the accommodating space 121 from the rear end of the upper cap 12. Thereafter, the upper cap 12 packed with the receiver 20 is coupled to the main body 11, so that the receiver 20 is completely received inside the wireless input apparatus 10 as shown in FIG. 3. To prevent the receiver 20 from being loosened or falling out, a latch mechanism having matching clasp parts is disposed on the receiver 20 and inside the accommodating space 121 in respective for interlocking the receiver 20 and the accommodating space 121 and thus securing the receiver inside the main body. As shown in FIG. 1˜FIG. 3, a socket 122 is disposed in the accommodating space 121 at a position corresponding to a plug 21 of the receiver 20. The structural design of the socket 122 can be a general slot capable of receiving and securing the plug 21. It is worth pointing out that the latch mechanism for interlocking the receiver 20 and the accommodating space 121 is not limited to the aforementioned socket 122 and plug 21 only, but it can any clasping structure, such as a hook or a spring, that is allowed under the interior space restriction of the wireless input apparatus 10, and the description above is provided for illustration only.

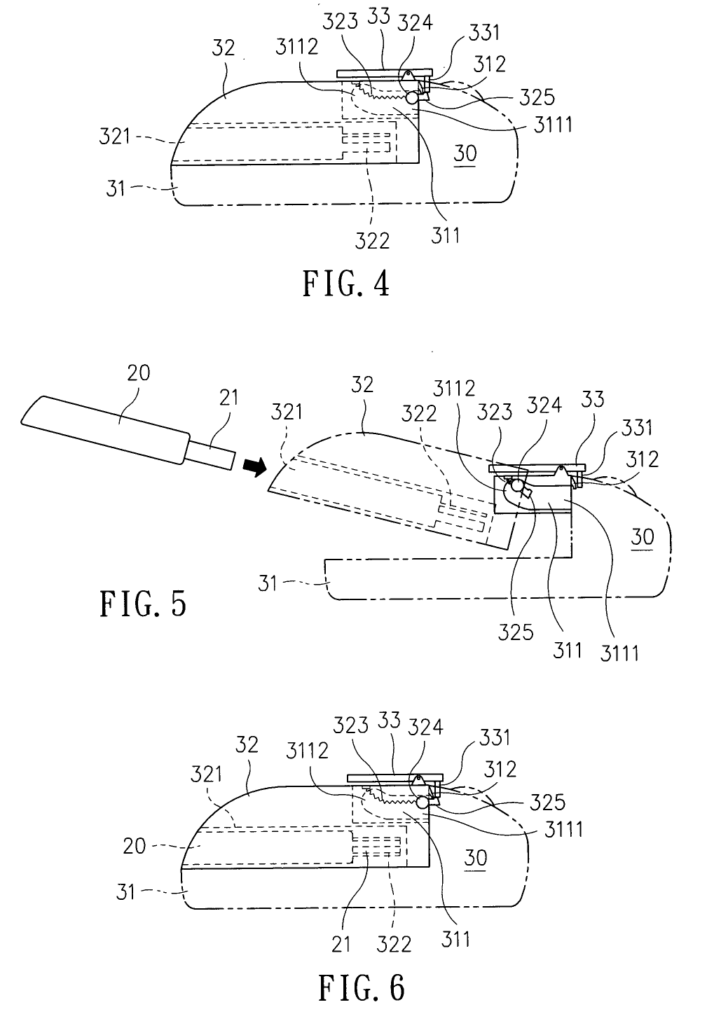

Please refer to FIGS. 4 to 6, which show a wireless input apparatus capable of storing a receiver according to another preferred embodiment of the present invention. The wireless input apparatus 30 is a wireless mouse having a main body 31, and a detachable flip-type upper cap 32, whereas a shaft 324, coupled to a hook 325, is arranged at the front end of the upper cap 32; and the main body 31 further comprises: a fixing rod 312; a sliding chute 311, having a first end 3111 and a second end 3112, for the shaft 324 to inset therein; and a spring 323, coupled between the shaft 324 and the second end 3112 of the sliding chute 311. In addition, the main body 31 has a press button 33, having a protruding portion 331 arranged at the bottom of the front end of the press button 33 while arranging the protruding portion 331 to correspond to; the fixing rod 312 of the main body 31. If the hook 325 is latched at the fixing rod 312 as shown in FIG. 4, the hook 325 will be situated below the protruding portion 331, and the upper cap 32 and the main body 31 can be closed by latching the hook 325 with the fixing rod 312. If the press button 33 is pressed as shown in FIG. 5, then the protruding portion 331 will separate the hook 325 from the fixing rod 312. When the hook 325 is released, the resilience force of the spring 323 will force the hook 325 to slide towards the second end 3112 of the sliding chute 311, so that the rear end of the upper cap 32 is lifted and tilted. Similar to the foregoing preferred embodiment, the bottom of the upper cap 32 has an accommodating space 321, which is unsealed at a rear end of the upper cap 32 and is in communication with outside world. After the receiver 20 is inserted into the accommodating space 321 from the rear end of the upper cap 32 as shown in FIG. 5, and the upper cap 32 is forced to engaged with the main body 31, the receiver 20 can be stored completely inside the wireless input apparatus 30 as shown in FIG. 6. In the accommodating space 321, a socket 322 is disposed at a position corresponding to the plug 21 of the receiver 20, and the structural design of the socket is similar to the structure of a general slot 322 for receiving and securing the plug 21, so as to prevent the receiver 20 from being loosened or falling off.

In summation of the description above, the wireless input apparatus capable of storing a receiver of the invention can store the receiver into the wireless input apparatus. Its structure and method are simple, and the invention definitely can achieve the effects of storing and carrying the receiver easily and reducing the volume of the mouse. Further, the wireless input apparatus includes a wireless mouse, a wireless keyboard or a wireless presenter.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A wireless input apparatus capable of storing a receiver, comprising:
a main body, having a detachable/rotatable upper cap; and
a receiver;
wherein, an unsealed accommodating space is disposed at the bottom of the upper cap for enabling the receiver to be inserted from the rear end of the upper cap into the accommodating space.

2. The wireless input apparatus capable of storing a receiver of claim 1, further comprising a latch mechanism having matching clasp parts disposed on the receiver and inside the accommodating space in respective for interlocking the receiver and the accommodating space and thus receiving the receiver inside the main body.

3. The wireless input apparatus capable of storing a receiver of claim 1, wherein the clasp part disposed inside the accommodating space is a socket arranged at a position corresponding to a plug, used as the matching clasp part of the receiver, for interlocking the two and thus securing the receiver.

4. The wireless input apparatus capable of storing a receiver of claim 1, wherein the wireless input apparatus is a device selected form the group consisting of a wireless mouse, a wireless keyboard and a wireless briefing device.

5. The wireless input apparatus capable of storing a receiver of claim 1, wherein the upper cap further comprises an shaft and a hook; and the main body further comprises: a fixing rod; a sliding chute, having a first end and a second end, for the shaft to inset therein; and a spring, coupled between the shaft and the second end of the sliding chute; and the upper cap is engaged with the main body as the hook is coupled to the fixing rod; and the upper cap is flipped upward and detached from the main body as the hook is separated from the fixing rod while the shaft is forced tp moved from the first end to the second end by the resilience of the spring.

6. The wireless input apparatus capable of storing a receiver of claim 5, wherein the main body further comprises a press button, to be pressed for separating the fixing rod and the hook.
